(19) United States
(12) Patent Application Publication
(10) Pub. No.: US 2021/0334760 A1
(43) Pub. Date: Oct. 28, 2021

(54) Method for Commercializing and Promoting Talents

(71) Applicant: Lulubite Ltd, Jerusalem (IL)

(72) Inventors: Assaf Bivas, Karkur Pardes Hana (IL); Gil Blumenfeld, Even Yehuda (IL); Dave Wolf, Ramat Bet Shemesh (IL)

(73) Assignee: Lulubite Ltd, Jerusalem (IL)

(21) Appl. No.: 16/858,631

(22) Filed: Apr. 26, 2020

(51) Int. Cl. G06Q 10/10; G06F 16/9535; G06F 16/9538

(52) U.S. Cl. CPC G06Q 10/1053; G06F 16/9538; G06F 16/9535

(57) ABSTRACT

A method for commercializing and promoting talented people that is performed by processing devices running on computing devices and remote servers. The method enables a user to open an account, sends to the user computerized forms with requirements to provide an access link to professional official profiles and internet profiles, accesses to these profiles and downloads information, allocates a talent card to the user, randomly chooses rankers from registered rankers pool, sends to these rankers the information with scaling questionnaires as to professional qualities of the user, receives the answers and calculates a personal score for the user, determines a commercial market value of the talent card of the user, and enables viewers to purchase the talent card or part of it and to order sponsorship services from the user.

### TECHNICAL FIELD

The present invention refers to a method based on an internet website for commercializing and promoting talents.

### BACKGROUND ART

Many talented people in a variety of fields wish to move forward professionally, to gain public and professional exposure, and to enhance their commercial potential. The present invention discloses an effective solution for these needs by providing a method that is in fact a web platform that enables a talented user to gain those goals.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 illustrates a computing device (100), another computing device (100A) and a remote server (200), that each of them includes a processing device (10).

### THE INVENTION

The main object of the present invention is to provide for commercializing and promoting talented people in a variety of fields. The method is performed by processing devices (10), in a remote server (200) and in computing devices (100). The term “computing device” (100) hereinafter and in the claims refers to any kind of device which is designed to have internet connection, such as smartphones, computers, tablets and the like.

A web platform such as a computer program or a mobile application may be used as a framework for the overall operation and use of the method and for the sake of fluency we will use the terms “web platform” and “method” hereinafter in this connection and as having in general the same meaning. A user of a computing device (100) may download the web platform which is performed by a processing device (10) of the computing device (100), and may be also performed by a processing device (10) in a remote server (200).

The method is designed specifically for commercializing and promoting talented people in a variety of fields.

The web platform enables a user of a computing device (100) to open through his or her computing device a professional account and to register as a talent user. The talent of the users can be of a variety of fields, such as, sports, football, basketball, swimming, cycling, art, singing, playing a musical instruments, dancing, painting, and so on.

The web platform also enables a user of a computing device (100) to register himself or herself through the computing device as an expert ranker in a specific talent field. Users that register themselves as expert rankers are usually users with knowledge in the specific talent fields in which they registered. It is not necessary that the expert rankers should be professional, but it is enough that they have the knowledge and ability to rank and to give a professional opinion on talented users who register as talented users.

The web platform sends from the remote server (200) to the computing device (100) of the talent user a first computerized form and presents to the talent user a requirement to indicate in the computerized form his or her talent field by choosing the talent field from two or more possible talent fields. It is possible and desirable that the web platform should include a variety of primary and sub-categories of talent areas from which the user should specify the talent he or she has.

The web platform sends from the server to the computing device a second computerized form and presenting to the user an additional requirement to type an access link to his or her professional official profile in an official database.

The web platform automatically access by the remote server through the internet to the professional official profile of the talent user in the official database according to the access link that the talent user provides. This step filters in fact people who are talented but without a minimal professional background. The aim is that only people that are engage seriously with their talent files will have the option to create a professional account. For example, a sportsman can provide a link to his professional official profile in the sport association of which he is a member; an artist can provide a link to his professional official profile in the artists association of which he is a member, and so forth. It is assumed that any person with a talent who has a professional profile in a professional or semi-professional association may have the minimal level to start commercializing his potential.

The web platform automatically downloads professional information from the professional official profile of the talent user and uploads this professional information to the professional account of the user.

The web platform sends from the remote server to the computing device a third computerized form and presents to the talent user another requirement to type an access link to his or her internet profiles, such as his or her profiles in LinkedIn™, Facebook™, Instagram™, YouTube™ and the like.

The web platform automatically access by the remote server through the internet to the internet profiles of the talent user, automatically downloads personal information from the internet profiles and uploads this personal information to the professional account of the talent user. It is assumed that this personal information that may include pictures, videos, texts and the like can be used to evaluate the level of the talent user.

The web platform sends from the server to the computing device a demand to the talent user to upload to his or her professional account a media content (videos, photos, texts), and enables the talent user to upload the media content to his or her professional account. The media content can give better information and details about the qualities and abilities of the user in his field of talent, which may be used to assess his level and his commercial potential.

The web platform allocates a talent card to the user. The meaning of the term “talent card” is similar this term when used regarding athletes and players for examples who have a player card that can belong to the teams in which they play or to themselves. The aim is to affix the commercial potential of the talent user to a “talent card” and to sell parts or percent of this talent card to the public. Also, the purchased parts are negotiable, so the buyer can later sell the part he bought at a higher price and profit margin.

The web platform automatically chooses randomly rankers from registered rankers in the talent field of the user. In fact the web platform may include a big number of expert rankers in each talent field. It is possible to send said information to hundreds of even thousands of expert rankers for getting better and more accurate answers as to the level and qualities of the talent user in question. Therefore, the web platform automatically gets predetermined number of random numbers by operating a computer random function. Then, the web platform associates the random numbers with the corresponding rankers from the registered rankers in the talent field of the user that are stored in the memory of the processing device in the server, and appointing these corresponding rankers to provide answers as to the qualities of the talent user.

The web platform automatically sends from the remote server to other computing devices (100A) of the appointed rankers that are stored in the memory of the processing device in the server the professional information, the personal information and the media content of the user.

The web platform automatically sends from the server to the computing devices of the appointed rankers a questionnaire that includes at least three scaling questions as to the professional qualities of the talent user to be answered on the scale of given range of values.

The web platform receives from the computing devices of the appointed rankers scaling answers to said questionnaire, and storing said scaling answers in the processing device in the server.

The web platform then calculating a by implementing a statistical function stored in the processing device in the server a personal score for the talent user based on the received scaling answers as weighting according to a specific weight that each ranker has and stored in the memory of the processing device in the server, and presenting the personal score in the professional account of the user. The term “scaling questions” means ranking questions that they present an option for respondents to rank the available answers to the questions on the scale of given range of values (for example from 1 to 10). In that way, the web platform can automatically analyzes the answers and automatically calculate a rank based on the answers from a large number of rankers.

The web platform determines a commercial market value of the talent card of the talent user based on his or her personal score, the professional information, an amount of followers of the internet profiles of the talented user as calculated by implementing a computer function stored in the processing device in the server, the media content and on his or her field of talent, and presenting the commercial market value of the talent card in his or her professional account.

The web platform enables viewers to purchase the talent card or part of it. Then the web platform stores in the processing device in the server details of the purchaser that includes his or her share. In response to such purchase the web platform to lists automatically in the professional account the details of the purchaser that are stored in the processing device in the server. The web platform may also include a system for selling and buying these shares, similar in a way to stock exchange.

The web platform enables viewers to order sponsorship services from the talent user, and enables viewers to donate money or goods to the user.

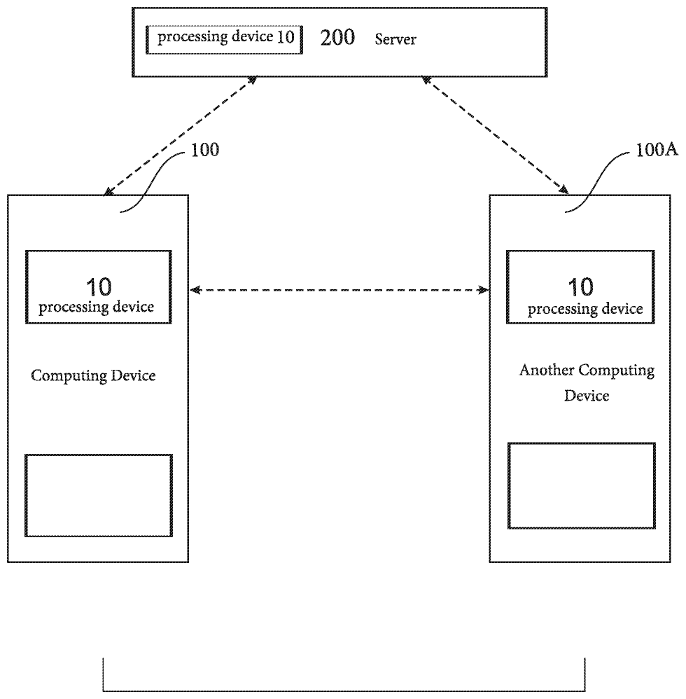

FIG. 1 illustrates a computing device (100), another computing device (100A) and a remote server (200), that each of them includes a processing device (10).

What is claimed is:

1. A method for commercializing and promoting talented people in a variety of fields that is performed by processing devices with a memory running on a computing device and a remote server, comprising:
(a) enabling a user of the computing device to open through the computing device a professional account and to register as a talent user or to register as an expert ranker in a specific talent field;
(b) sending automatically from the remote server to the computing device of the talent user a first computerized form presenting to the talent user a requirement to indicate in the computerized form his or her talent field by choosing the talent field from two or more possible talent fields;
(c) sending automatically from the remote server to the computing device of the talent user a second computerized form and presenting to the talent user an additional requirement to type an access link to his or her professional official profile in an official database;
(d) accessing automatically by the remote server through the interne to the professional official profile of the user in the official database and downloading professional information from said professional official profile and uploading this professional information to the professional account of the talent user;
(e) sending automatically from the remote server to the computing device of the talent user a third computerized form and presenting to the talent user another requirement to type an access link to his or her internet profiles;
(f) accessing automatically by the remote server through the internet to the internet profiles of the talent user and downloading personal information from said internet profiles and uploading this personal information to the professional account of the talent user;
(g) sending automatically from the server to the computing device of the talent user a demand to the talent user to upload to his or her professional account a media content (videos, photos, texts) and enabling the talent user to upload the media content that can be a type of videos, photos, recordings or texts to his or her professional account;
(h) allocating automatically a talent card to the talent user;
(i) getting predetermined number of random numbers by operating a computer random function, associating said random numbers with corresponding rankers from the registered rankers in the talent field of the user that are stored in the memory of the processing device in the server, and appointing said corresponding rankers;
(j) sending automatically from the remote server to another computing devices of the appointed rankers that are stored in the memory of the processing device in the server the professional information, the personal information and the media content of the user;
(k) sending from the server to the computing devices of the appointed rankers a questionnaire that includes at least five scaling questions as to the professional qualities of the talent user to be answered on the scale of given range of values;
(l) receiving from the computing devices of the appointed rankers scaling answers to said questionnaire, and storing said scaling answers in the processing device in the server;
(m) calculating by implementing a statistical function stored in the processing device in the server a personal score for the talent user based on the scaling answers from the appointed rankers as weighting according to a specific weight that each ranker has and stored in the memory of the processing device in the server, and presenting the personal score in the professional account of the user;
(n) determining a commercial market value of the talent card of the talent user based on his or her personal score, the professional information, an amount of followers of the internet profiles of the talented user as calculated by implementing a computer function stored in the processing device in the server, the media content and on his or her field of talent, and presenting the commercial market value of the talent card in his or her professional account;
(o) enabling viewers to purchase the talent card or part of it;
(p) storing in the processing device in the server details of the purchaser that includes his or her share;
(q) listing in the professional account in response to said purchase the details of the purchaser that are stored in the processing device in the server;
(r) enabling viewers to order sponsorship services from the talent user, and enabling viewers to donate money or goods to the talented user.
